(19) United States
(12) Patent Application Publication
(10) Pub. No.: US 2021/0098919 A1
(43) Pub. Date: Apr. 1, 2021

(54) TERMINAL FITTING

(71) Applicant: Yazaki Corporation, Tokyo (JP)

(72) Inventor: Masahiro Nakagawa, Shizuoka (JP)

(21) Appl. No.: 17/037,720

(22) Filed: Sep. 30, 2020

(30) Foreign Application Priority Data
Oct. 1, 2019 (JP) 2019-181306

(51) Int. Cl. H01R 13/187; H01R 4/18

(52) U.S. Cl. CPC H01R 13/187; H01R 4/18

(57) ABSTRACT

Provided is a terminal fitting that includes: a terminal connector to be electrically connected to a counterpart terminal fitting; an electric-wire connector selected from a plurality of kinds of electric-wire connectors formed separately from the terminal connector for each connection form with respect to an electric wire We to be connected physically and electrically; and a coupling structure configured as a common structure between the terminal connector and the electric-wire connectors, the coupling structure being configured to couple the terminal connector with the selected electric-wire connector.

### CROSS-REFERENCE TO RELATED APPLICATION(S)

The present application claims priority to and incorporates by reference the entire contents of Japanese Patent Application No. 2019-181306 filed in Japan on Oct. 1, 2019.

### BACKGROUND OF THE INVENTION

### 1. Field of the Invention

The present invention relates to a terminal fitting.

### 2. Description of the Related Art

Conventionally, as for a terminal fitting, a main body thereof is formed as an integrally molded article that includes a terminal connection part to be electrically connected to a counterpart terminal fitting and an electric-wire connection part to be physically and electrically connected to an electric wire. For example, this type of terminal fitting is disclosed in Japanese Patent No. 5579213.

By the way, regarding the terminal fitting, a connection form of an electric wire with respect to the electric-wire connection part (a connection structure between the electric-wire connection part and the electric wire, lead-out directions of the electric wire from the electric-wire connection part, and the like) is determined according to various kinds of design requirements such as its installation place, use environment, and the like. For example, as for the terminal fitting, if a connection structure using crimp connection is suited for the design requirements when determining the connection structure with respect to the electric wire, an electric-wire connection part corresponding to a crimp connection structure is formed. Meanwhile, if a connection structure using fusion connection is suited for the design requirements, an electric-wire connection part corresponding to a fusion connection structure is formed. Further, as for the terminal fitting, if a lead-out direction along the terminal connecting direction with the counterpart terminal fitting is suited for the design requirements when determining the lead-out direction of the electric wire from the electric-wire connection part, an electric-wire connection part with such a lead-out direction is formed. Meanwhile, if a lead-out direction along a direction intersecting the terminal connecting direction is suited, an electric-wire connection part with such a lead-out direction is formed. As described, conventionally, it is necessary to prepare terminal fittings of different specifications with different shapes of electric-wire connection parts for each connection form of electric wires. Therefore, it is concerned that the conventional terminal fittings may cause a great increase in the cost.

### SUMMARY OF THE INVENTION

It is therefore an object of the present invention to provide a terminal fitting capable of reducing the cost.

In order to solve the above mentioned problem and achieve the object, a terminal fitting according to one aspect of the present invention includes a terminal connector to be electrically connected to a counterpart terminal fitting; an electric-wire connector selected from a plurality of kinds of electric-wire connectors formed separately from the terminal connector for each connection form with respect to an electric wire to be connected physically and electrically; and a coupling structure configured as a common structure between the terminal connector and the electric-wire connectors, the coupling structure being configured to couple the terminal connector with the selected electric-wire connector.

According to another aspect of the present invention, in the terminal fitting, it is preferable that the connection form between the electric-wire connector and the electric wire is a physical and electrical connection structure between the electric-wire connector and the electric wire or/and a lead-out direction of the electric wire in the electric-wire connector and the electric wire connected physically and electrically.

According to still another aspect of the present invention, in the terminal fitting, it is preferable that one of the electric-wire connectors includes two piece-parts that are to be crimp-connected to the electric wire by being wound around the electric wire.

According to still another aspect of the present invention, in the terminal fitting, it is preferable that one of the electric-wire connectors includes a cylindrical part configured to crimp-connect from an outer side to the electric wire inserted into an inner side of the cylindrical part.

According to still another aspect of the present invention, in the terminal fitting, it is preferable that one of the electric-wire connectors includes an electric-wire connection part that is to be fusion-connected or solder-connected to the electric wire.

According to still another aspect of the present invention, in the terminal fitting, it is preferable that the electric-wire connectors are broadly classified into a kind of electric-wire connector in which the electric wire is led out along a terminal connecting direction between the terminal connector and the counterpart terminal fitting, and to a kind of electric-wire connector in which the electric wire is led out along a direction intersecting the terminal connecting direction.

According to still another aspect of the present invention, in the terminal fitting, it is preferable that the coupling structure includes: a first screw part provided to the terminal connector; a coupled part provided to the electric-wire connector, the coupled part having a through-hole that is coaxial with a screw axis of the first screw part; and a screw member including a second screw part to be fit to the first screw part by screwing, the screw member fastening the coupled part to the terminal connector via the through-hole.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view illustrating a terminal fitting according to an embodiment;

FIG. 2 is an exploded perspective view of the terminal fitting according to the embodiment when viewed from another angle;

FIG. 3 is an exploded perspective view illustrating a terminal connector;

FIG. 4 is a sectional view illustrating the terminal connector;

FIG. 5 is a perspective view illustrating a terminal fitting in which the terminal connector and a first electric-wire connector are coupled;

FIG. 6 is a perspective view of the terminal fitting in which the terminal connector and the first electric-wire connector are coupled, when viewed from another angle;

FIG. 7 is a perspective view illustrating a terminal fitting in which the terminal connector and a second electric-wire connector are coupled;

FIG. 8 is a perspective view of the terminal fitting in which the terminal connector and the second electric-wire connector are coupled, when viewed from another angle;

FIG. 9 is a perspective view illustrating a terminal fitting in which the terminal connector and a third electric-wire connector are coupled;

FIG. 10 is a perspective view of the terminal fitting in which the terminal connector and the third electric-wire connector are coupled, when viewed from another angle;

FIG. 11 is a perspective view illustrating a terminal fitting in which the terminal connector and a fourth electric-wire connector are coupled; and

FIG. 12 is a perspective view of the terminal fitting in which the terminal connector and the fourth electric-wire connector are coupled, when viewed from another angle.

### DETAILED DESCRIPTION OF THE PREFERRED EMBODIMENT

Hereinafter, an embodiment of the terminal fitting according to the present invention will be described in detail by referring to the accompanying drawings. Note that the present invention is not limited by the embodiment.

### Embodiment

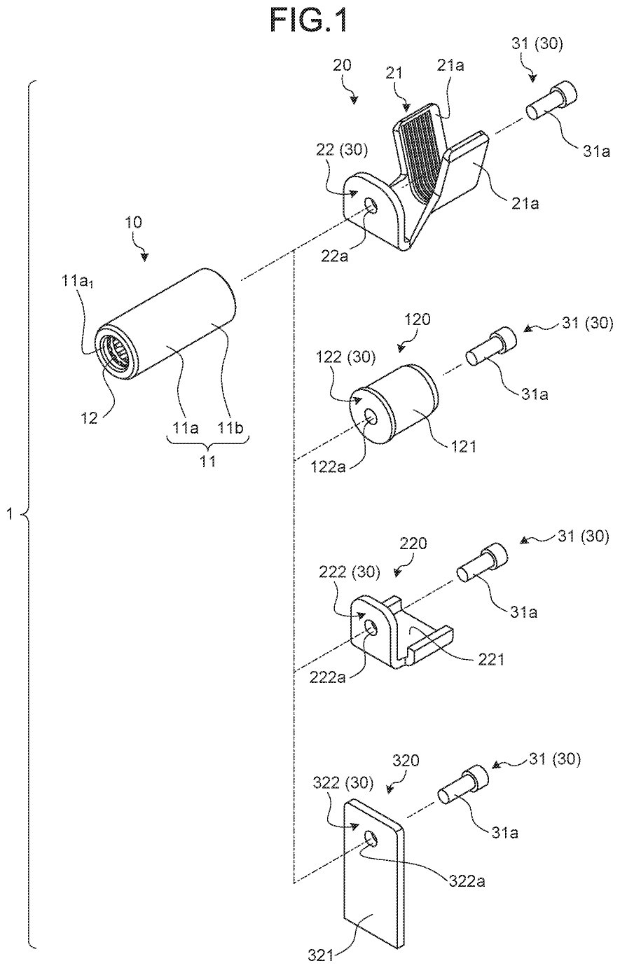

An embodiment of the terminal fitting according to the present invention will be described by referring to FIG. 1 to FIG. 12.

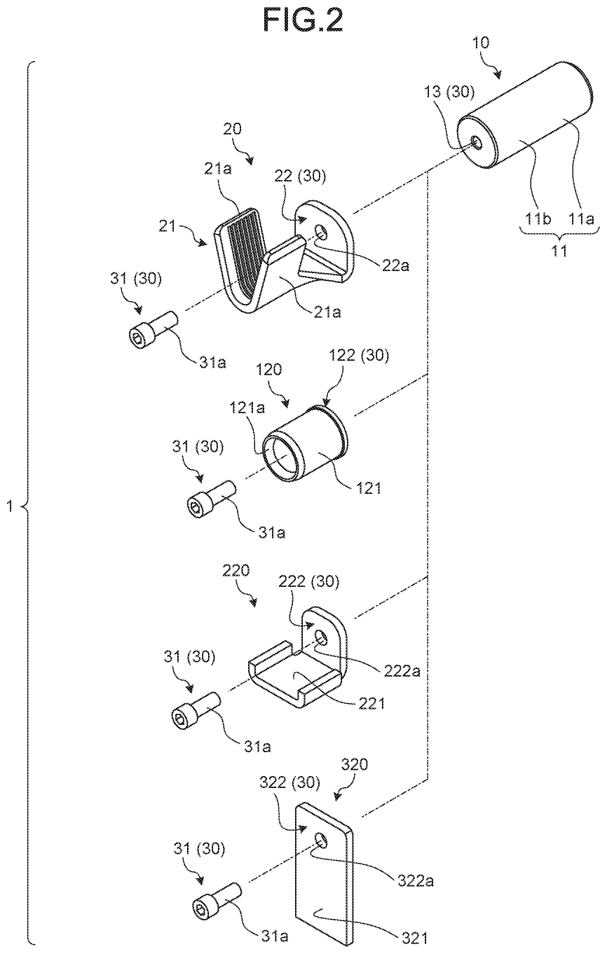

Reference sign 1 in FIG. 1 to FIG. 12 denotes the terminal fitting of the embodiment. The terminal fitting 1 includes: a terminal connector 10 to be electrically connected to a matching terminal fitting (not illustrated); and one electric-wire connector selected from a plurality of kinds of electric-wire connectors (first to fourth electric-wire connectors 20, 120, 220, and 320) formed separately from the terminal connector 10 for each connection form with respect to an electric wire We to be physically and electrically connected (FIG. 1 and FIG. 2). The connection form between the electric-wire connector (one of the first to fourth electric-wire connectors 20, 120, 220, and 320) and the electric wire We means a physical and electrical connection structure between the electric-wire connector (any one of the first to fourth electric-wire connectors 20, 120, 220, and 320) and the electric wire We or/and a lead-out direction of the electric wire We in the physically and electrically connected electric-wire connector (one of the first to fourth electric-wire connectors 20, 120, 220, and 320) and electric wire We.

For convenience, the first to fourth electric-wire connectors 20, 120, 220, and 320 are illustrated herein as examples of a plurality of electric-wire connectors. However, the electric-wire connector as a structural element of the terminal fitting 1 is not necessarily limited to those four kinds. Further, for convenience, one kind of electric wire We is illustrated herein as an example of a connection target of the first to fourth electric-wire connectors 20, 120, 220, and 320. However, different kinds of electric wires We (for example, wires with different wire diameters) may be used in a plurality of kinds of electric-wire connectors.

Further, the terminal fitting 1 is configured to have a common structure between the terminal connector 10 and a plurality of kinds of electric-wire conductors (first to fourth electric-wire connectors 20, 120, 220, and 320), and includes a coupling structure 30 configured to couple the terminal connector 10 with a selected electric-wire connector (any one of the first to fourth electric-wire connectors 20, 120, 220, and 320) (FIG. 1, FIG. 2, and FIG. 4 to FIG. 12).

The terminal fitting 1 does not require any specific electric connection form with respect to the counterpart terminal fitting. Therefore, the terminal fitting 1 may be configured to be electrically connected to the counterpart terminal fitting in a direct manner or configured to be electrically connected to the counterpart terminal fitting in an indirect manner. In a case where the terminal fitting 1 is electrically connected to the counterpart terminal fitting in a direct manner, the terminal fitting 1 may be fitted and connected to the counterpart terminal fitting, or may be fixed to the counterpart terminal fitting with a screw, for example. Herein, the terminal fitting 1 that is fitted and connected to the counterpart terminal fitting will be illustrated as an example. Therefore, either one of the terminal fitting 1 as an example and the counterpart terminal fitting is formed as a female terminal shape, and the other is formed as a male terminal shape. The terminal fitting 1 is configured as a female terminal herein.

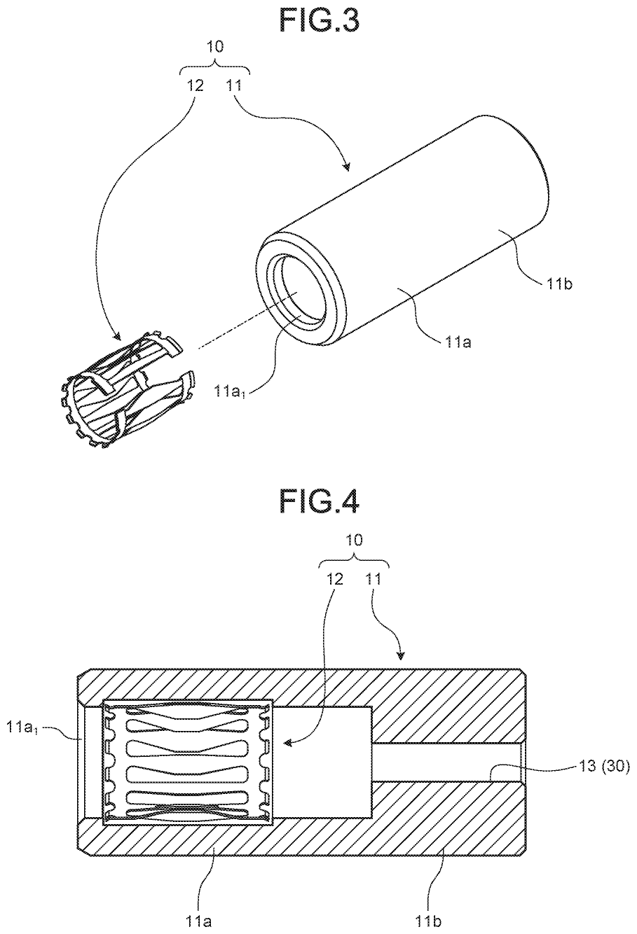

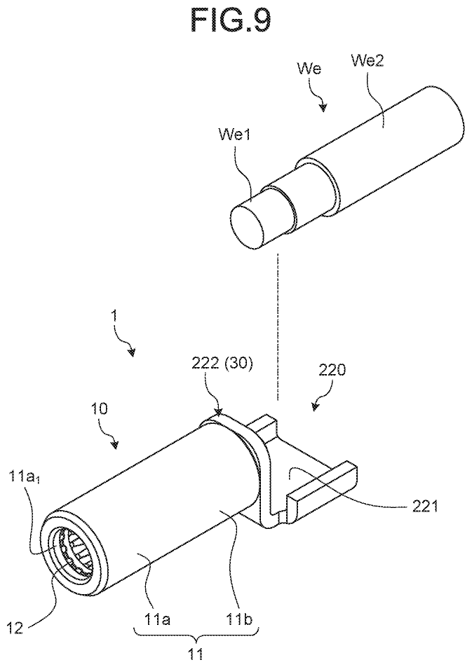

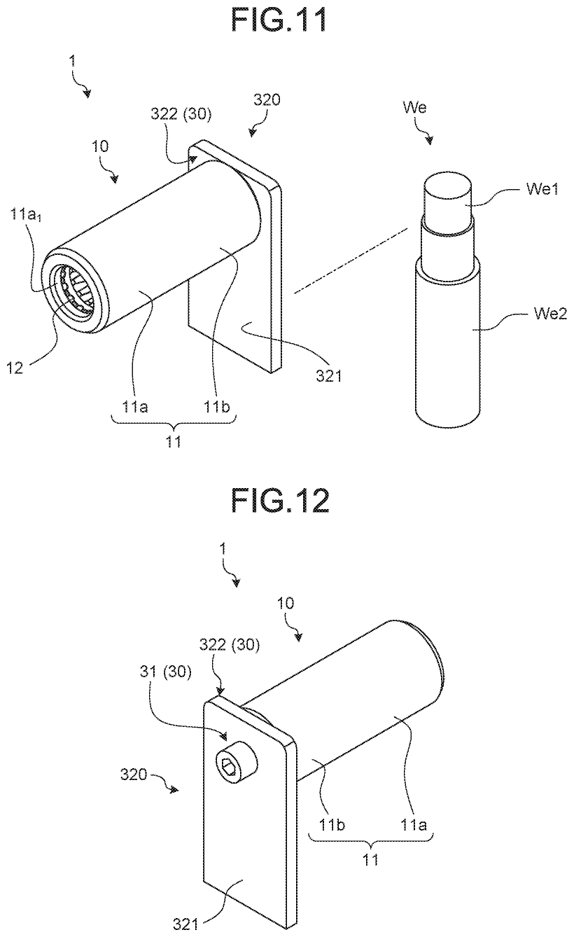

This exemplary terminal connector 10 includes a terminal main body 11 and a contact member 12 (FIG. 1, FIG. 3 to FIG. 5, FIG. 7, FIG. 9, and FIG. 11). Each of the terminal main body 11 and the contact member 12 is formed with a conductive material such as a metal. As for the exemplary terminal connector 10, the counterpart terminal fitting is electrically connected to the terminal main body 11 via the contact member 12.

The terminal main body 11 includes a terminal connection part 11a that is fitted and connected to the counterpart terminal fitting, and a coupling part 11b for coupling one electric-wire connector selected from the electric-wire connectors (first to fourth electric-wire connectors 20, 120, 220, and 320) (FIG. 1 to FIG. 12). As for the exemplary terminal main body 11, the terminal connection part 11a is formed in a cylindrical shape, and the coupling part 11b is formed coaxially with the terminal connection part 11a and formed in a columnar shape having the same outer diameter as that of the terminal connection part 11a. In the terminal main body 11, the cylinder axis direction of the terminal connection part 11a is the terminal connecting direction or the terminal pull-out direction between the terminal main body 11 and the counterpart terminal fitting. With the terminal main body 11, a columnar counterpart terminal fitting is inserted into an inside space of the terminal connection part 11a from an opening 11a1 (FIG. 1, FIG. 3 to FIG. 5, FIG. 7, FIG. 9, and FIG. 11).

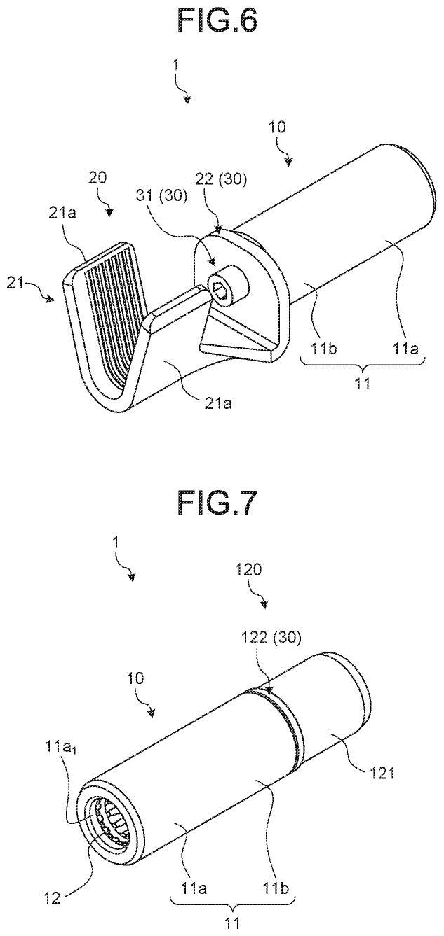

In the coupling part 11b of the terminal main body 11, a screw part (referred to as “first screw part” hereinafter) 13 as one of the structural elements of a coupling structure 30 is provided (FIG. 2 and FIG. 4). The first screw part 13 has a screw axis that is coaxial with the coupling part 11b. Thus, the screw axis of the first screw part 13 is along the terminal connecting direction between the terminal connector 10 and the counterpart terminal fitting. The coupling structure 30 includes, as a separate structural element from the first screw part 13, a screw member 31 to be fit to the first screw part 13 by screwing (FIG. 1, FIG. 2, and FIG. 6). The screw member 31 includes a screw part (referred to as “second screw part” hereinafter) 31a to be screwed into the first screw part 13.

Note here that the first screw part 13 may be a female screw part or may be a male screw part as long as it functions as the terminal fitting 1 and is capable of connecting the electric wire We to the electric-wire connector (any one of the first to fourth electric-wire connectors 20, 120, 220, and 320). In this example, a female screw part formed coaxially with the coupling part 11b is used as the first screw part 13, and a male screw member is used as the screw member 31 to be screwed into the first screw part 13.

The contact member 12 is an elastically deformable member, and placed in an inside space of the terminal connection part 11a. This exemplary contact member 12 forms a cylinder, and is brought in contact with an inner peripheral surface of the terminal connection part 11a coaxially with the terminal connection part 11a. The contact member 12 is elastically deformed by being pressed toward the outer side in the radial direction by an outer peripheral surface of the counterpart terminal fitting inserted into the inside space of the terminal connection part 11a such as to electrically connect the counterpart terminal fitting to the terminal connection part 11a.

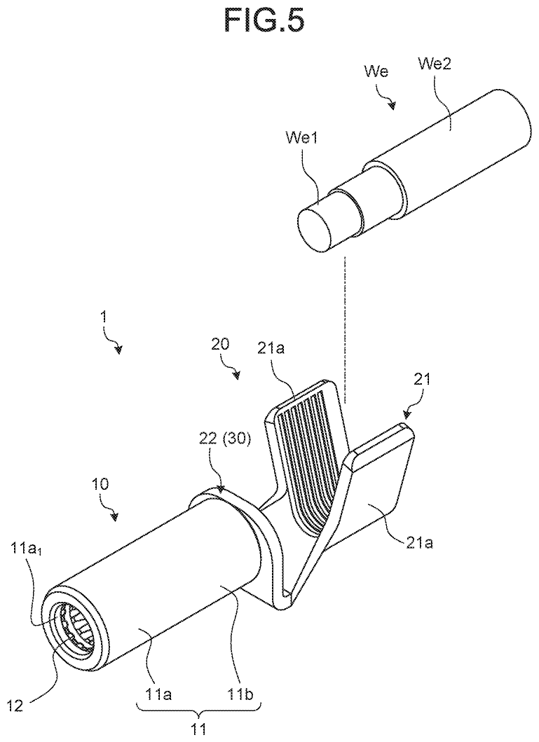

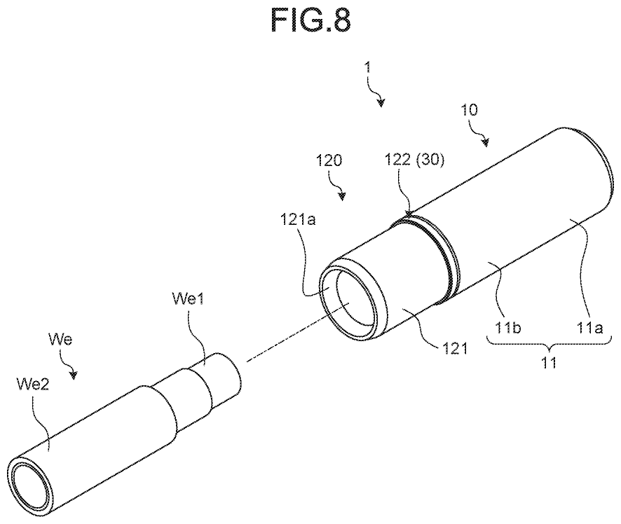

Each of the first to fourth electric-wire connectors 20, 120, 220, and 320 is presented as an example to be physically and electrically connected to the electric wire We (FIG. 5, FIG. 8, FIG. 9, and FIG. 11). At a terminal of the electric wire We, a core wire We1 is exposed by removing a coating We2. Each of the first to fourth electric-wire connectors 20, 120, 220, and 320 is formed with a conductive material such as a metal.

The first electric-wire connector 20 employs a crimp connection structure as the connection structure with respect to the electric wire We (FIG. 5). Further, the first electric-wire connector 20 is configured to lead out the electric wire We along the terminal connecting direction between the terminal connector 10 and the counterpart terminal fitting (FIG. 5).

The first electric-wire connector 20 includes an electric-wire connection part 21 to be crimp-connected to the electric wire We (FIG. 5). The electric-wire connection part 21 illustrated herein is formed in a U-like shape or a V-like shape having two piece-parts (the so-called barrel pieces) 21a to be wound around the electric wire We for crimp connection. The electric-wire connection part 21 may include two sets that are a pair of piece-parts 21a to be crimp-connected while being caulked and wound around the uncoated core wire We1 at the terminal of the electric wire We and a pair of piece-parts 21a to be crimp-connected while being caulked and wound around a coated core wire We2 at the terminal of the electric wire We. Note, however, that the exemplary electric-wire connection part 21 is presented to include a set of the pair of piece-parts 21a to be crimp-connected to the core wire We1 at the terminal of the electric wire We and the coated wire We2 collectively. Further, the pair of piece-parts 21a may employ the so-called B crimp structure, or may be a structure that enables crimp connection by winding one of the piece-parts 21a around the other piece-part 21a from the outer side. With the first electric-wire connector 20, the electric wire We is led out from the electric-wire connection part 21 that is crimp-connected to the terminal.

Further, the first electric-wire connector 20 includes, as one of the structural elements of the coupling structure 30, a coupled part 22 that is coupled to the coupling part 11b of the terminal connector 10 (FIG. 1, FIG. 2, FIG. 5, and FIG. 6).

As described above, the terminal connector 10 includes, in the coupling part 11b, the first screw part 13 along the terminal connecting direction. Thus, in the coupled part 22, formed is a through-hole 22a that is coaxial with the screw axis of the first screw part 13 and the screw axis of the second screw part 31a of the screw member 31 (FIG. 1 and FIG. 2).

Further, as described above, with the first electric-wire connector 20, the electric wire We is led out along the terminal connecting direction. Therefore, the through-hole 22a is formed such that its hole axis goes along the lead-out direction of the electric wire We from the electric-wire connection part 21.

The exemplary coupled part 22 is formed in a flat-plate piece shape, and disposed at an end part of the electric-wire connection part 21 on the opposite side of the lead-out direction of the electric wire We. Further, the exemplary coupled part 22 includes the through-hole 22a formed along the orthogonal direction to the plane thereof. Thus, by coupling the terminal connector 10 with the first electric-wire connector 20, the terminal fitting 1 is formed as the so-called straight-type terminal fitting.

With the screw member 31, the second screw part 31a is inserted into the through-hole 22a from the electric-wire connection part 21 side and the second screw part 31a is screwed into the first screw part 13 of the coupling part 11b so as to fasten the coupled part 22 to the terminal connector 10 via the through-hole 22a. Thereby, with the terminal fitting 1, protrusion of the screw member 31 toward the outer side with respect to the terminal connector 10 and the first electric-wire connector 20 can be prevented, so that it is possible to prevent an increase in the size of the entire body frame.

The second electric-wire connector 120 employs a crimp connection structure as the connection structure with respect to the electric wire We (FIG. 8). Further, the second electric-wire connector 120 is configured to lead out the electric wire We along the terminal connecting direction between the terminal connector 10 and the counterpart terminal fitting (FIG. 8).

The second electric-wire connector 120 includes an electric-wire connection part 121 to be crimp-connected to the electric wire We (FIG. 5). The electric-wire connection part 121 illustrated herein is formed as a cylindrical part configured to crimp-connect from the outer side to the electric wire We inserted into the inner side of the cylindrical part. The exemplary electric-wire connection part 121 is formed in a cylindrical shape. Further, toward the inside space of the electric-wire connection part 121, the uncoated core wire We1 of the terminal of the electric wire We is inserted into the inside space thereof from an opening 121a at one end with its axis being along the cylinder axis direction (FIG. 8). The electric-wire connection part 121 is crimp-connected to the uncoated core wire We1 while being caulked at a plurality of points from the outer side of the radial direction toward the inner side of the radial direction. Thereby, with the second electric-wire connector 120, the electric wire We is led out from the electric-wire connection part 121 that is crimp-connected to the terminal.

Further, the second electric-wire connector 120 includes, as one of the structural elements of the coupling structure 30, a coupled part 122 that is coupled to the coupling part 11b of the terminal connector 10 (FIG. 1, FIG. 2, FIG. 7, and FIG. 8).

As in the case of the first electric-wire connector 20, in the coupled part 122 of the second electric-wire connector 120, formed is a through-hole 122a that is coaxial with the screw axis of the first screw part 13 and the screw axis of the second screw part 31a of the screw member 31 (FIG. 1). As in the case of the through-hole 22a of the first electric-wire connector 20, the through-hole 122a is formed such that its hole axis goes along the lead-out direction of the electric wire We from the electric-wire connection part 121. Further, the through-hole 122a is formed to communicate with the inner space of the electric-wire connection part 121.

The exemplary coupled part 122 is formed in a disk shape, and disposed at an opening of the other end of the electric-wire connection part 121. Further, the exemplary coupled part 122 includes the through-hole 122a formed along the orthogonal direction to the plane thereof. Thus, by coupling the terminal connector 10 with the second electric-wire connector 120, the terminal fitting 1 is formed as the so-called straight-type terminal fitting.

With the screw member 31, the second screw part 31a is inserted into the through-hole 122a from the inside space of the electric-wire connection part 121 and the second screw part 31a is screwed into the first screw part 13 of the coupling part 11b so as to fasten the coupled part 122 to the terminal connector 10 via the through-hole 122a. Thereby, with the terminal fitting 1, there is no protrusion of the screw member 31 toward the outer side with respect to the terminal connector 10 and the second electric-wire connector 120, so that it is possible to prevent an increase in the size of the entire body frame.

Note here that the exemplary through-hole 122a is formed such that its hole axis is disposed coaxially with the cylinder axis of the electric-wire connection part 121 before being crimp-connected. Thus, with the second electric-wire connector 120, the axis of the electric wire We after being crimp-connected is disposed substantially coaxially with the cylinder axis of the terminal connection part 11a of the terminal connector 10. Therefore, the terminal fitting 1 is capable of being fitted and connected to the counterpart terminal fitting by coupling the terminal connector 10 with the second electric-wire connector 120 without minding the position around the axis of the terminal connector 10.

The third electric-wire connector 220 employs a fusion connection structure achieved by laser welding or the like or a solder connection structure as the connection structure with respect to the electric wire We (FIG. 9). Further, the third electric-wire connector 220 is configured such that the electric wire We is led out along the terminal connecting direction between the terminal connector 10 and the counterpart terminal fitting (FIG. 9).

The third electric-wire connector 220 includes an electric-wire connection part 221 that is to be fusion-connected or solder-connected to the electric wire We (FIG. 9). The electric-wire connection part 221 illustrated herein is formed in a rectangular flat-plate shape, and the uncoated core wire We1 at the terminal of the electric wire We is fusion-connected or solder-connected to one of the planes thereof. With the electric-wire connection part 221, the electric wire We is led out along the plane thereof and along the orthogonal direction to one of the sides.

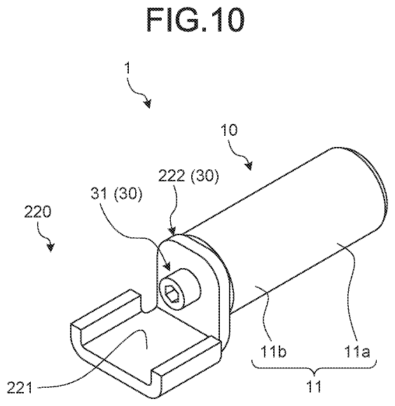

Further, the third electric-wire connector 220 includes, as one of the structural elements of the coupling structure 30, a coupled part 222 that is coupled to the coupling part 11b of the terminal connector 10 (FIG. 1, FIG. 2, FIG. 9, and FIG. 10).

As in the case of the first electric-wire connector 20 and the second electric-wire connector 120, in the coupled part 222 of the third electric-wire connector 220, formed is a through-hole 222a that is coaxial with the screw axis of the first screw part 13 and the screw axis of the second screw part 31a of the screw member 31 (FIG. 1 and FIG. 2). As in the cases of the respective through-holes 22a and 122a of the first electric-wire connector 20 and the second electric-wire connector 120, the through-hole 222a is formed such that its hole axis goes along the lead-out direction of the electric wire We from the electric-wire connection part 221.

As in the case of the coupled part 22 of the first electric-wire connector 20, the exemplary coupled part 222 is formed in a flat-plate piece shape, and disposed at an end part (side) of the electric-wire connection part 221 on the opposite side of the lead-out direction of the electric wire We. Further, as in the case of the coupled part 22 of the first electric-wire connector 20, the exemplary coupled part 222 includes the through-hole 222a formed along the orthogonal direction to the plane thereof. Thus, by coupling the terminal connector 10 with the third electric-wire connector 220, the terminal fitting 1 is formed as the so-called straight-type terminal fitting.

With the screw member 31, the second screw part 31a is inserted into the through-hole 222a from the electric-wire connection part 221 side and the second screw part 31a is screwed into the first screw part 13 of the coupling part 11b so as to fasten the coupled part 222 to the terminal connector 10 via the through-hole 222a. Thereby, with the terminal fitting 1, protrusion of the screw member 31 toward the outer side with respect to the terminal connector 10 and the third electric-wire connector 220 can be prevented, so that it is possible to prevent an increase in the size of the entire body frame.

The fourth electric-wire connector 320 employs a fusion connection structure or a solder connection structure as the connection structure with respect to the electric wire We (FIG. 11). Further, the fourth electric-wire connector 320 is configured such that the electric wire We is led out along a direction intersecting the terminal connecting direction between the terminal connector 10 and the counterpart terminal fitting (FIG. 11).

The fourth electric-wire connector 320 includes an electric-wire connection part 321 that is to be fusion-connected or solder-connected to the electric wire We (FIG. 11). Further, the fourth electric-wire connector 320 includes, as one of the structural elements of the coupling structure 30, a coupled part 322 that is coupled to the coupling part 11b of the terminal connector 10 (FIG. 1, FIG. 2, FIG. 11, and FIG. 12). The fourth electric-wire connector 320 illustrated herein is formed in a rectangular flat-plate shape, and divided into an area to be used as the electric-wire connection part 321 and an area used as the coupled part 322 although there is no specific mark that can be visually recognized.

In the electric-wire connection part 321, the uncoated core wire We1 at the terminal of the electric wire We is fusion-connected or solder-connected to one of the plane thereof. With the electric-wire connection part 321, the electric wire We is led out along the plane thereof and along the orthogonal direction to one of the sides.

As in the cases of the respective coupled parts 22, 122, and 222 of the first to third electric-wire connectors 20, 120, and 220, in the coupled part 322, formed is a through-hole 322a that is coaxial with the screw axis of the first screw part 13 and the screw axis of the second screw part 31a of the screw member 31 (FIG. 1 and FIG. 2). As described above, with the fourth electric-wire connector 320, the electric wire We is led out along the direction (herein, the orthogonal direction) intersecting the terminal connecting direction between the terminal connector 10 and the counterpart terminal fitting. Therefore, the through-hole 322a is formed such that its hole axis goes along the direction (herein, the orthogonal direction) intersecting the lead-out direction of the electric wire We from the electric-wire connection part 321.

In the exemplary fourth electric-wire connector 320, an area on one of the sides thereof from which the electric wire We is led out is used as the electric-wire connection part 321, and an area on the other side that is the opposite side of the lead-out direction of the electric wire We is used as the coupled part 322. Thus, by coupling the terminal connector 10 with the fourth electric-wire connector 320, the terminal fitting 1 is formed as the so-called L-type terminal fitting.

With the screw member 31, the second screw part 31a is inserted into the through-hole 322a and the second screw part 31a is screwed into the first screw part 13 of the coupling part 11b so as to fasten the coupled part 322 to the terminal connector 10 via the through-hole 322a. Thereby, with the terminal fitting 1, protrusion of the screw member 31 toward the outer side with respect to the terminal connector 10 and the fourth electric-wire connector 320 can be prevented, so that it is possible to prevent an increase in the size of the entire body frame.

As described above, the terminal fitting 1 according to the embodiment is configured by preparing the terminal connector 10 and the electric-wire connectors (first to fourth electric-wire connectors 20, 120, 220, and 320) as separate components such as to be able to share the terminal connector 10 with those, regardless of the connection form with respect to the electric wire We in the electric-wire connectors (first to fourth electric-wire connectors 20, 120, 220, and 320). Sharing the terminal connector 10 results in simplifying the management of the components and makes it possible to avoid redesigning of the terminal fittings to be suited for the connection forms of electric wires of different specifications. Therefore, with the terminal fitting 1 of the embodiment, the cost can be reduced. Further, sharing the terminal connector 10 results tin simplifying and downsizing the packing materials when transporting the terminal connectors 10 to the installation area of the electric-wire connectors (first to fourth electric-wire connectors 20, 120, 220, and 320), thereby making it possible to reduce the transportation cost as well. Therefore, the terminal fitting 1 of the embodiment is capable of reducing the cost in this regards as well.

Note here that the terminal fitting 1 of the embodiment is configured to be able to correspond to the electric wires We of the same wire diameter in accordance with the allowable current value that can pass through the terminal connector 10, for example. By preparing a plurality of kinds of electric-wire conductors (for example, the first to fourth electric-wire connectors 20, 120, 220, and 320) corresponding to the electric wire We of the same wire diameter, the terminal fitting 1 of such a case can combine those with the terminal connector 10. Further, the terminal fitting 1 of the embodiment can combine the terminal connector 10 with a plurality of kinds of electric-wire conductors (for example, the first to fourth electric-wire connectors 20, 120, 220, and 320) corresponding to the electric wires We of different diameters within a range of allowable current values of the terminal connector 10, for example. In that case, for example, a plurality of kinds of first electric-wire connectors 20 corresponding to the electric wires We of different wire diameters may be prepared, or a plurality of kinds of second electric-wire connectors 120 corresponding to the electric wires We of different wire diameters may be prepared. Further, with the terminal fitting 1 of the embodiment, a plurality of kinds of terminal connectors (for example, the terminal connector 10 described above, a fitting-connection type terminal connector, a screw-fixing type terminal connector, a fusion-type terminal connector, and the like in different shapes) provided with the first screw part 13 of the same shape may be prepared, and one of the electric-wire connectors (for example, any one of the first to fourth electric-wire connectors 20, 120, 220, and 320) may be combined therewith, or a plurality of kinds of electric-wire connectors (for example, the first to fourth electric-wire connectors 20, 120, 220, and 320) may also be combined therewith.

In the embodiment, the coupling structure 30 using screwing is employed. Thus, as for the terminal fitting 1 of the embodiment, the terminal connector 10 and a plurality of kinds of electric-wire connectors (for example, the first to fourth electric-wire connectors 20, 120, 220, and 320) are prepared as separate components but the coupling force therebetween is strong, so that it is possible to secure vibration resistance while vehicles are traveling, for example. Note that the coupling structure 30 is not limited to be achieved by screwing but any other structures such as a fusion structure and the like may be employed, as long as vibration resistance can be secured therewith.

The terminal fitting according to the present embodiment is configured to prepare the terminal connector and the electric-wire connectors as separate components so as to be able to share the terminal connector with the electric-wire connectors, regardless of the connection form with respect to the electric wire in the electric-wire connector. Therefore, it is possible with the terminal fitting to reduce the cost.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal fitting, comprising:
a terminal connector to be electrically connected to a counterpart terminal fitting;
an electric-wire connector selected from a plurality of kinds of electric-wire connectors formed separately from the terminal connector for each connection form with respect to an electric wire to be connected physically and electrically; and
a coupling structure configured as a common structure between the terminal connector and the electric-wire connectors, the coupling structure being configured to couple the terminal connector with the selected electric-wire connector.

2. The terminal fitting according to claim 1, wherein
the connection form between the electric-wire connector and the electric wire is a physical and electrical connection structure between the electric-wire connector and the electric wire or/and a lead-out direction of the electric wire in the electric-wire connector and the electric wire connected physically and electrically.

3. The terminal fitting according to claim 1, wherein
one of the electric-wire connectors includes two piece-parts that are to be crimp-connected to the electric wire by being wound around the electric wire.

4. The terminal fitting according to claim 2, wherein
one of the electric-wire connectors includes two piece-parts that are to be crimp-connected to the electric wire by being wound around the electric wire.

5. The terminal fitting according to claim 1, wherein
one of the electric-wire connectors includes a cylindrical part configured to crimp-connect from an outer side to the electric wire inserted into an inner side of the cylindrical part.

6. The terminal fitting according to claim 2, wherein
one of the electric-wire connectors includes a cylindrical part configured to crimp-connect from an outer side to the electric wire inserted into an inner side of the cylindrical part.

7. The terminal fitting according to claim 3, wherein
one of the electric-wire connectors includes a cylindrical part configured to crimp-connect from an outer side to the electric wire inserted into an inner side of the cylindrical part.

8. The terminal fitting according to claim 1, wherein
one of the electric-wire connectors includes an electric-wire connection part that is to be fusion-connected or solder-connected to the electric wire.

9. The terminal fitting according to claim 2, wherein
one of the electric-wire connectors includes an electric-wire connection part that is to be fusion-connected or solder-connected to the electric wire.

10. The terminal fitting according to claim 3, wherein
one of the electric-wire connectors includes an electric-wire connection part that is to be fusion-connected or solder-connected to the electric wire.

11. The terminal fitting according to claim 5, wherein
one of the electric-wire connectors includes an electric-wire connection part that is to be fusion-connected or solder-connected to the electric wire.

12. The terminal fitting according to claim 1, wherein
the electric-wire connectors are broadly classified into a kind of electric-wire connector in which the electric wire is led out along a terminal connecting direction between the terminal connector and the counterpart terminal fitting, and to a kind of electric-wire connector in which the electric wire is led out along a direction intersecting the terminal connecting direction.

13. The terminal fitting according to claim 2, wherein
the electric-wire connectors are broadly classified into a kind of electric-wire connector in which the electric wire is led out along a terminal connecting direction between the terminal connector and the counterpart terminal fitting, and to a kind of electric-wire connector in which the electric wire is led out along a direction intersecting the terminal connecting direction.

14. The terminal fitting according to claim 3, wherein
the electric-wire connectors are broadly classified into a kind of electric-wire connector in which the electric wire is led out along a terminal connecting direction between the terminal connector and the counterpart terminal fitting, and to a kind of electric-wire connector in which the electric wire is led out along a direction intersecting the terminal connecting direction.

15. The terminal fitting according to claim 5, wherein
the electric-wire connectors are broadly classified into a kind of electric-wire connector in which the electric wire is led out along a terminal connecting direction between the terminal connector and the counterpart terminal fitting, and to a kind of electric-wire connector in which the electric wire is led out along a direction intersecting the terminal connecting direction.

16. The terminal fitting according to claim 8, wherein
the electric-wire connectors are broadly classified into a kind of electric-wire connector in which the electric wire is led out along a terminal connecting direction between the terminal connector and the counterpart terminal fitting, and to a kind of electric-wire connector in which the electric wire is led out along a direction intersecting the terminal connecting direction.

17. The terminal fitting according to claim 1, wherein
the coupling structure includes:
a first screw part provided to the terminal connector;
a coupled part provided to the electric-wire connector, the coupled part having a through-hole that is coaxial with a screw axis of the first screw part; and
a screw member including a second screw part to be fit to the first screw part by screwing, the screw member fastening the coupled part to the terminal connector via the through-hole.

18. The terminal fitting according to claim 2, wherein
the coupling structure includes:
a first screw part provided to the terminal connector;
a coupled part provided to the electric-wire connector, the coupled part having a through-hole that is coaxial with a screw axis of the first screw part; and
a screw member including a second screw part to be fit to the first screw part by screwing, the screw member fastening the coupled part to the terminal connector via the through-hole.

19. The terminal fitting according to claim 3, wherein
the coupling structure includes:
a first screw part provided to the terminal connector;
a coupled part provided to the electric-wire connector, the coupled part having a through-hole that is coaxial with a screw axis of the first screw part; and
a screw member including a second screw part to be fit to the first screw part by screwing, the screw member fastening the coupled part to the terminal connector via the through-hole.

20. The terminal fitting according to claim 5, wherein
the coupling structure includes:
a first screw part provided to the terminal connector;
a coupled part provided to the electric-wire connector, the coupled part having a through-hole that is coaxial with a screw axis of the first screw part; and
a screw member including a second screw part to be fit to the first screw part by screwing, the screw member fastening the coupled part to the terminal connector via the through-hole.
